(19) United States
(12) Patent Application Publication
(10) Pub. No.: US 2007/0261100 A1
(43) Pub. Date: Nov. 8, 2007

(54) Platform independent distributed system and method that constructs a security management infrastructure

(76) Inventors: Robert L. Greeson, Broussard, LA (US); Ronald C. Hebert, Lafayette, LA (US); Ricky J. Palombo, Lafayette, LA (US); Joey D. Russo, Lafayette, LA (US); Antonio J. Velazquez, New Iberia, LA (US)

Correspondence Address: PERRET DOISE;A PROFESSIONAL LAW CORPORATION, P.O. DRAWER 3408, LAFAYETTE, LA, 70502-3408, US

(21) Appl. No.: 11/418,851

(22) Filed: May 5, 2006

(51) Int. Cl. H04L 9/00

(52) U.S. Cl. 726/1

(57) ABSTRACT

Platform independent distributed software that constructs a security management infrastructure for different locations is described. The software includes a control manager module regulating access to critical business assets. The control manager interfaces with and bridges various type of biometric software and hardware systems. The software further includes a tracking model consisting of a custom report generation tool for monitoring people, business critical assets, and events in any particular location. In addition to tracking and access control, the software provides an event notification service for registering, monitoring, and storing primary/composite events into a modeled event history database. The software is integrated into three components. One component is the company headquarters integrated with platform independent legacy software comprising multi-tiered ERP and business packages for cross domain security management and monitoring. Another component is the managed location where the access control regions are held and the main tracking software is installed. The final component is the client software integrated with the biometric devices, regulating authentication for people, assets, and/or events.

### BACKGROUND OF THE INVENTION

This invention relates to a system and method for security management. More specifically, but without limitation, this invention relates to a platform independent distributed system that constructs a security management infrastructure for different locations.

Organization's face significant security challenges in today's world, where protecting vital business data can be an expensive and difficult. For example, a business must proactively address security concerns that impact the applications, databases and other business assets essential to daily operations. A business must convert raw security data into actionable business intelligence. A business must comply with regulations, such as those dictated by the government. Most importantly, a business must ensure continuous business operations by mitigating risk at virtually every level of your organization all while maintaining budgets and achieving operational efficiencies.

Meeting these challenges requires a model for security management that weaves the disparate elements that protect your business assets into a single, complete and easily managed solution. A security management model should align security with business needs by integrating three critical components in the security environment: user identity and access management, threat management and security information management. Each component must be open and flexible, easily integrating with one another as well as with third-party solutions. Finally, security management demands a proactive approach and on-demand response to events within the ever changing security environment.

When properly implemented, integrated security management enables users to understand the security environment in all of its complexity, turning security data into actionable information, obtaining timely answers to critical questions and, based on those answers, taking action to protect people, assets, and information across your entire enterprise whatever your business model or organizational structure.

The model for on-demand security management solutions delivers the flexibility required to align every aspect of the organization's security issues with its business needs by automating, simplifying and streamlining processes. In addition, it provides real-time visibility into the multitude of security events that occur daily in your business environment enabling the right response at the right time.

In most enterprises, users' identities and their access privileges are a core function for conducting business. Behind those identities are the employees, contractors, partners, investors and others who drive every aspect of operations. Identity management determines who has access to what intranets, applications, databases and platforms, and enables basic functions such as email. Key questions that must be answered by the identity and access component of security management are: Who has access to what? What did they do? When did they do it?

By answering these questions, users can effectively align security with business goals, protect vital business assets, streamline business operations and achieve regulatory compliance. To date, user identity and access have been approached as separate entities when, in fact, they are integrally related and should be considered as a whole. The new security management model integrates these two functions, enabling communication and appropriate access based on identity without creating vulnerabilities. In addition, it bars unauthorized users from the network while giving authorized user's access to the information that they need to do their jobs and keep the business running and secure.

In recent years, systems have been developed that monitor changes within a particular environment. These systems are called event systems and their main purpose is to notify the external entities about the changes occurred within the domain of interest. Today, event systems are needed in many areas like graphical user interfaces, active databases, web applications, network monitoring applications and etc. Several tools have been developed for each of these fields, trying to satisfy the needs of the clients. The design for the heterogeneous event services brought many researches in the area of system architectures, matching algorithms, communication models and security.

Security information management is an emerging area of security management, made necessary by the management of secure information generated by disparate physical and IT security systems, platforms, and applications. Each of these entities generates information in a different way, presents it in a different format, stores it in a different place and reports it to a different location. A robust information management layer is needed for protecting the data, generating reports and allowing the authorized and authenticated users access the data.

This incessant flood of data literally, millions of messages daily from incompatible security technologies overwhelm the security infrastructure, resulting in security information overload and creating a negative impact on business operations. With no way to manage and integrate information, this fragmented approach often leads to duplication of effort, high overhead, weak security models and failed audits.

A Security Management System (SMS) is an element to corporate management responsibility which sets out an organization's security policies and its intent to manage security as an integral part of its overall business processes. It is based on the same concepts used for Safety Management System which significantly reduced the number of safety accidents in the aviation industry since its inception. Developed in conjunction with an efficient threat assessment mechanism, SMS will help an organization develop more proactive, efficient and cost effective security measures. The aim of SMS is the establishment of formalized security best practices developed whilst making sure the operational environment and limitations of the organization are taken into consideration. SMS provides an organization-wide approach to security through the development of a security culture as well as a system-wide security model encouraging and dependent on close co-operation between all stakeholders and regulators.

Therefore, it is an object to integrate the three key components of security management (identity and management, event management and information management) into a proactive solution that allows a business achieve operational efficiencies and regulatory compliance, as well as contain costs, mitigate risk and ensure continuous business operations. This object and many others will become apparent by a reading of the following disclosure.

### SUMMARY OF THE INVENTION

The invention relates to an improved method, apparatus and computer system for platform independent distributed software that constructs a security management infrastructure for different locations. The invention can be implemented in numerous ways, including as a method, a computer system, and an apparatus. The most preferred embodiments of the invention are disclosed below.

In a first preferred embodiment, a location independent control manager is disclosed. The control manager regulates access to critical business assets by interfacing with and bridging various types of biometric identification software and hardware systems. The control manager consists of a display interface with a touch screen resistance panel displaying the stored images of each person. Authorization is provided by pressing on the corresponding image and confirming the identity. Authentication may be provided by entering personal identification number on the touch screen keypad.

The control manager further includes a software module that interfaces with a secure keyless biometric access control system that provides people using their fingerprints to gain access to a critical business asset. The control manager also includes a software interface with a secure keyless biometric access control system that provides scanning the retina of the people for gaining access to a critical business asset. The system may further include location dependent tracking software. The tracking software enables the mobility of the security management system by the web portal and web service. It also enables the generation of user-defined reports and user defined events. The tracking software is fully described in the following pages. The system may further include the legacy software (sometimes referred to as the middleware software). The legacy software enables a communication path between the enterprise resource planning database management system (ERP DBMS) and the managed location DBMS.

In yet a second preferred embodiment (which is the most preferred embodiment of this application), a platform independent distributed system that constructs a security management infrastructure for different locations by integrating people information, asset information, and event information, is disclosed. The system includes a control manager, regulating access to assets information by interfacing with and bridging a biometric means; a tracking model, comprising a web portal, a web service, a custom report generation tool, and an event notification service for monitoring people information, the assets information, and the events information; and a web portal for mobile control of the system. The system further includes a custom report generation tool means for providing report generation and viewing interfaces with auto-scheduling for periodic generation; an event notification service means for registering, monitoring, and storing primary/composite events in to a modeled event history database; and a client side middleware interfacing with multi-tier enterprise models (Oracle, SAP, Microsoft SQL Server, Microsoft Great Plains, etc.) as a business object comprising cross domain security management and monitoring.

In this second preferred embodiment, the control manager may consist of an interface with a touch screen resistance panel displaying the stored images of each person assigned to particular location, and wherein for authorization, each person, accessing a critical business asset is suppose to click on his/her image and confirm his/her identity (name, initial, etc.), and wherein for authentication, after clicking on the corresponding image, a person has to enter his/her personal identification number on the touch screen keypad in order to finalize his/her approval for clearance.

Alternatively, the control manager may consists of an interface with a secure keyless biometric access control system that requires people using their fingerprints to gain access to a critical business asset and wherein for authorization and/or authentication, no keys, cards, personal identification numbers are required. A user simply gets the approval for entrance by putting his/her pre-determined finger for fingerprint identification.

The control manager may consist of an interface with a secure keyless biometric access control system that provides scanning the retina of a person for gaining access to a critical business asset, and wherein for authorization and/or authentication, no keys, cards, personal identification numbers. A person simply gets the approval for entrance through retina scanning.

The custom report generation tool may include a report generator, a report generation interface and a report viewer interface simple enough for any user to run and view his/her reports, while maintaining the power and versatility to get the reports he/she needs.

Alternatively, the custom report generation tool may include where the reports are newly run whenever requested, which means that the data is always up-to-date; the user selects and runs a report from a menu of several standard, pre-defined reports (these reports can be used as they are, modified, or copied and modified to create entirely new reports, as described below). Also, the user modifies the date range for the report by selecting from a list of pre-defined ranges. The custom range allows a user to specify a start date and an end date, and on some reports includes a start and end time. The user can modify selection criteria (the criteria for which records will be included in the report). Selection criteria include, but are not limited to name, surname, social security number, assigned location, duty and date of employment, authorization code, customer status, customer class, day of call (Monday, Tuesday, etc.), phone number, duration, organization, service, site, state, station, time of call, transaction class, trunk, trunk group, etc. The user can customize various features of the report, such as its type (summary, detail, frequency or most/least), the columns to be used and their relative positions, etc. Additionally, the user can modify an existing report and saves the changes to an existing report or to a completely new report on the report menu. Also, the user can directly edit the report definition file for advanced features not directly changeable through the user interface described so far.

In the second preferred embodiment, the web portal software package may comprise a query interface for the modification, extraction and insertion of data into managed tables, a report generation interface for communication with the custom report generation tool and obtaining reports online; a full text search interface integrated on the managed data for text based queries; and an event registration interface for primitive and composite event scheduling with task allocation.

The web service software package may comprise a people scheduling interface for making daily/monthly/yearly reservations for people at managed locations; and, a tracking interface for querying the managed data within the location.

The event notification software package may include a predefined list of primitive events and operators; a composite event registration interface for defining and scheduling composite events; a task allocation interface for associating particular tasks with the stored composite events; an event monitoring interface for listening to the primitive events through external ports; and an event trigger interface for firing the primitive/composite events, storing them into the history database and running the registered tasks.

The client side middleware comprises database access and configuration interface for extracting personal data from ERP database management system (DBMS); daily/monthly/yearly people scheduling interface for periodic reservations; a SQL editor for querying the ERP DBMS; and, an object upload interface for extracting the binary personal data (photo, fingerprint, retina, etc.) from the DBMS.

An advantage of the present system is that the system provides a comprehensive security management solution. The system delivers multiple benefits, including reduced costs, less downtime, increased productivity and regulatory compliance. It enables you to make the right decisions at the right time. Furthermore, security management enhances overall security posture and increases your efficiency and effectiveness. In a dynamic computing environment where system reconfiguration and deployment are ongoing events, the system herein disclosed ensures: protection of critical business assets from intruders; proactive risk mitigation by reducing vulnerabilities; enforcement of security policies; automated provisioning and maintenance of digital identities; convenient, secure access to critical business assets by all users; integrated solutions, with centralized control of the extended security infrastructure.

### BRIEF DESCRIPTION OF THE DRAWINGS

FIG. 1 is a schematic that illustrates the tracking systems security management region.

FIG. 2 is a schematic that illustrates the security management system network layout.

FIG. 3 is a schematic that illustrates the security management system network scalability.

FIG. 4 is a block diagram that illustrates the tracking systems legacy software interface.

FIG. 5 is a block diagram that illustrates the tracking systems legacy software architecture.

FIG. 6 is a block diagram that illustrates the security managed location software components.

FIG. 7 is a block diagram that illustrates the location component: People Scheduling Web Service Module.

FIG. 8 is a block diagram that illustrates the location component: Web Portal Module.

FIG. 9 is a block diagram that illustrates the location component: Event Notification Service Module.

### DETAILED DESCRIPTION OF THE INVENTION

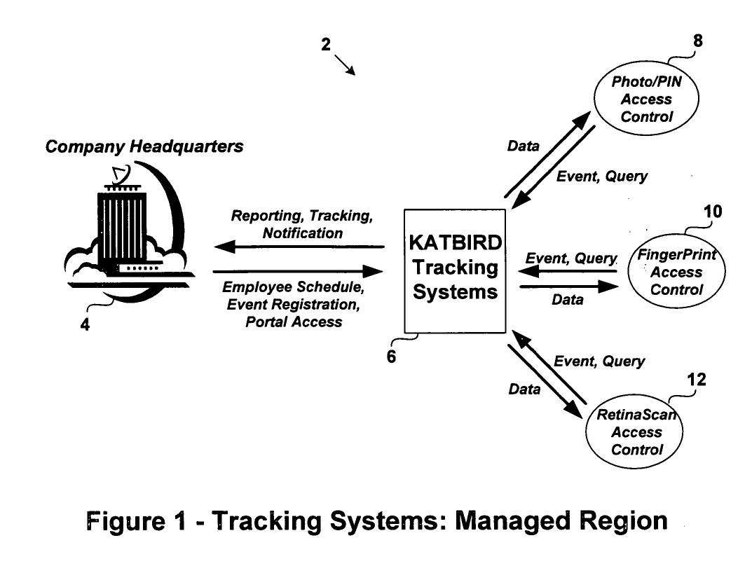

The present invention provides a security management system (SMS) for regulating access control, tracking the people/assets/events, facilitating reporting and event notification services for users. With reference to FIG. 1, the system's security management region in accordance with the embodiment of the invention is shown. In the most preferred embodiment, the system includes a .NET Framework based enterprise computer system capable of reliably (and asynchronously) communicating with any number of associated partners regardless of their respective protocols, document schemas, etc.

In the described embodiment, the SMS is coupled to an e-user which can, and usually does, have its own standards and practices for conducting a security management policy. It should be noted that the tracking systems can be in any technology other than .NET. In the most preferred embodiment, the system 2 is implemented using the “C#” (C-Sharp) programming language which provides a managed and unmanaged coding, automated garbage collection and object orientation.

The tracking software is a security management system installed as a distributed infrastructure covering at least three unique locations. These locations are the company headquarters 4, target security managed locations 6 (such as offshore rigs, plants, schools, hospitals, etc.) and the access control regions 8, 10, 12 within the target locations. SMS covers at least three units of different types; there can be multiple locations, multiple access control regions, and branch offices. FIG. 1 shows an offshore rig as the target location 6. As per the teachings of the present invention, the system can cover any number of unique locations beyond the base level (headquarter, target location, access control region, etc.).

As seen in FIG. 1, from company headquarters 4, users can schedule people to the secured target location. Users can further track the scheduled people and assets at the location. Users can get notified by the target location based on any set of registered events. Users can acquire daily/monthly/yearly reports from the target location. The central module of the tracking system is located at the target location 6. The central module is responsible for generating reports, registering and monitoring events, operating a web portal, and regulating access control. The control regions include photo identification 8 systems and biometric systems (Fingerprint access control, 10, Retina Scan access control, 12, etc.). These biometric systems are part of the security management system and are commercially available by different vendors.

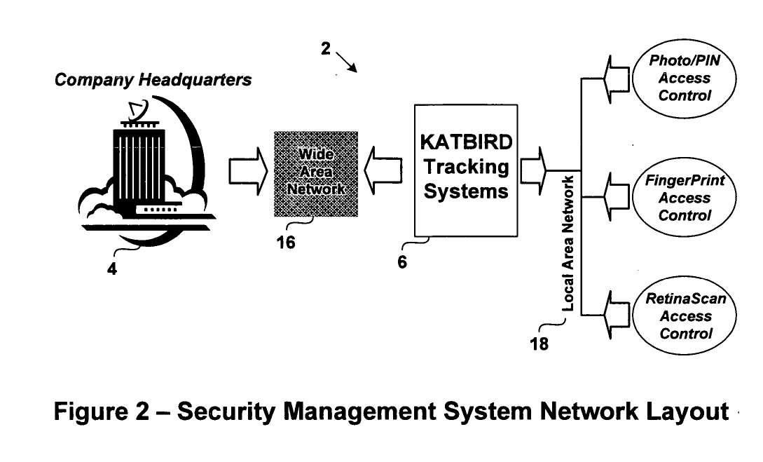

FIG. 2 is a diagram illustrating the network architecture of the SMS. The managed region between company headquarters 4 and the target location 6 is distributed across a wide area network 16. The managed region between the target location 6 and the access control devices are distributed across a wireless or wired local area network 18 within the target location.

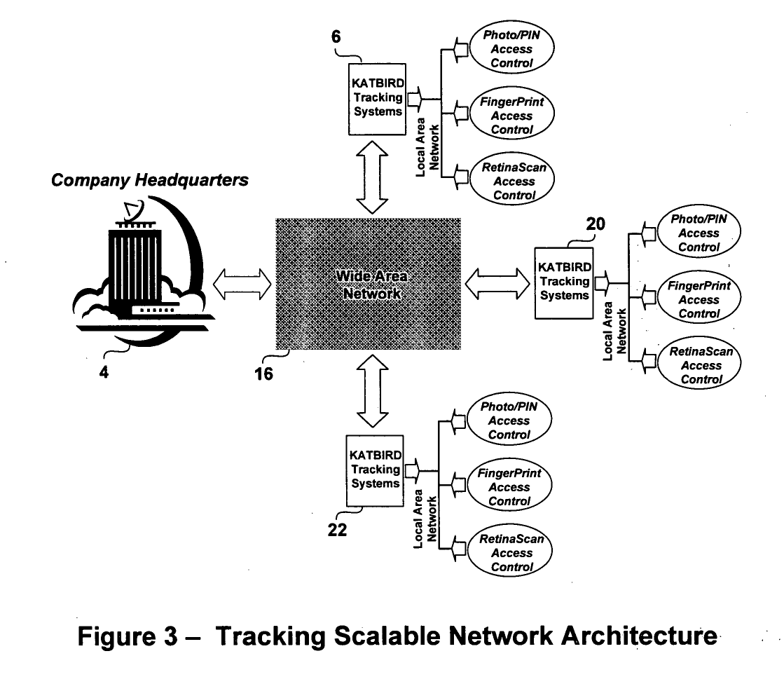

FIG. 3 is a diagram illustrating the scalability of the networked architecture where an enterprise can hold multiple target locations that need to be tracked by the SMS from the headquarters target location 4. The user can control each target location 6, 20, 22 independently via the WAN 16. SMS covers the entire structure as its managed region. Locations 6, 20, and 22 are equipped with tracking systems.

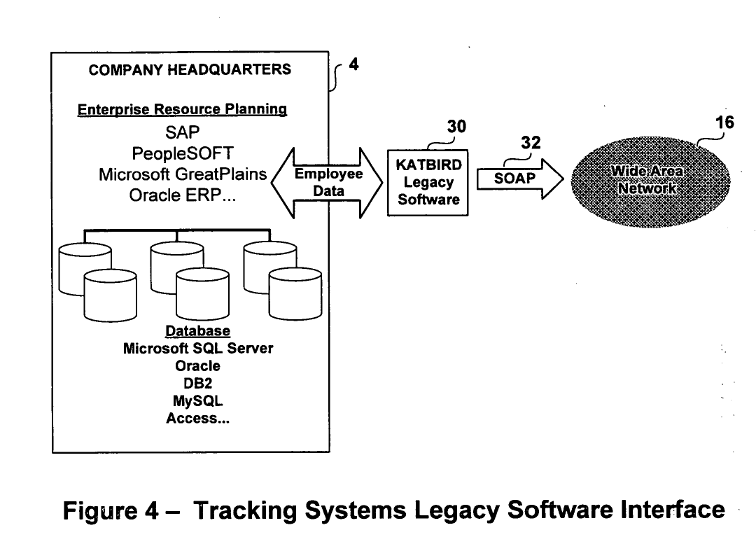

FIG. 4 is a diagram illustrating the legacy interface 30 between the company headquarters 4 and the target locations. The middleware is responsible for interacting with the enterprise resource planning packages (ERP) like SAP, Microsoft Great Plains, People Soft, etc . . . to schedule people at any particular location in the managed region. With the legacy software, the users at the headquarters 4 indirectly control the people scheduling without any relocation to the target locations. The middleware retrieves the personal data from the ERP Database Management System and after compression and encryption the data is sent to the target SMS location via the wide area network 16 using Simple Object Access Protocol (SOAP) 32.

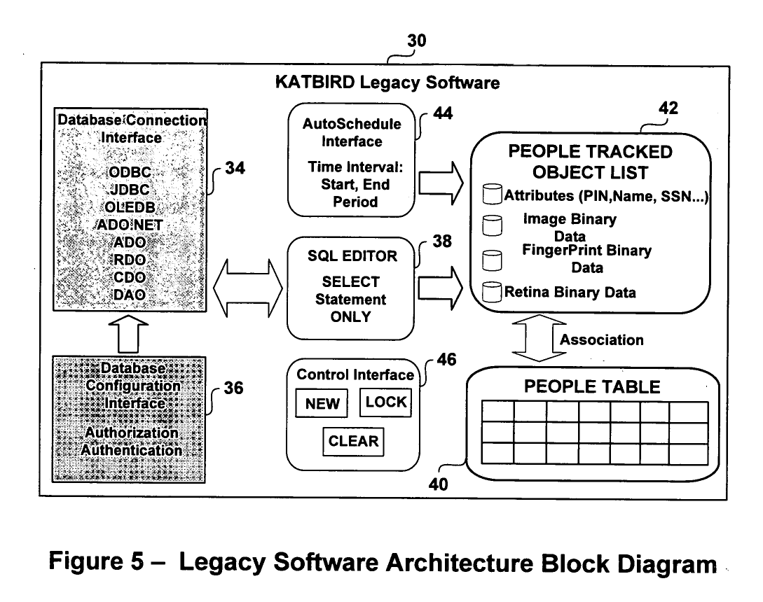

FIG. 5 is a block diagram illustrating the modular architecture of the legacy software 30. The software consists of a database connection interface 34 for communicating with the DBMS of the ERP system using standard access technologies (ADO.NET, ODBC, DAO, etc . . . ). The authorization and authentication module 36 is responsible for administrative level configuration to communicate with the DBMS. The SQL editor 38 provides users to write “SELECT” type queries to retrieve people data (name, social security number, personal identification number, etc . . . ) into “PEOPLE” table grid 40. The software is implemented in a way to retrieve the image binary data from ERP for regulating the access control. The image binary data includes fingerprint images, retina images, photographs, etc. The data can be indirectly retrieved from the DBMS as binary objects using the SQL editor 38 or they can be directly retrieved from their stored folders using the “People Tracked Object List” Interface 42.

The user can automate the task of scheduling 44 after reserving a time interval for the extracted list of people. The time interval can be based on daily, monthly and yearly reservations. After a person's reservations are completed, the user presses the “LOCK” button 46 to start scheduling at the selected periodic or non-periodic time intervals. “CLEAR” button 48 is to reset the current configuration and “NEW” button 50 is to open a new configuration form for another target SMS location. The people data including the binary objects are encrypted and compressed and ready to be communicated to the target location of interest when the reserved schedule triggers within the system.

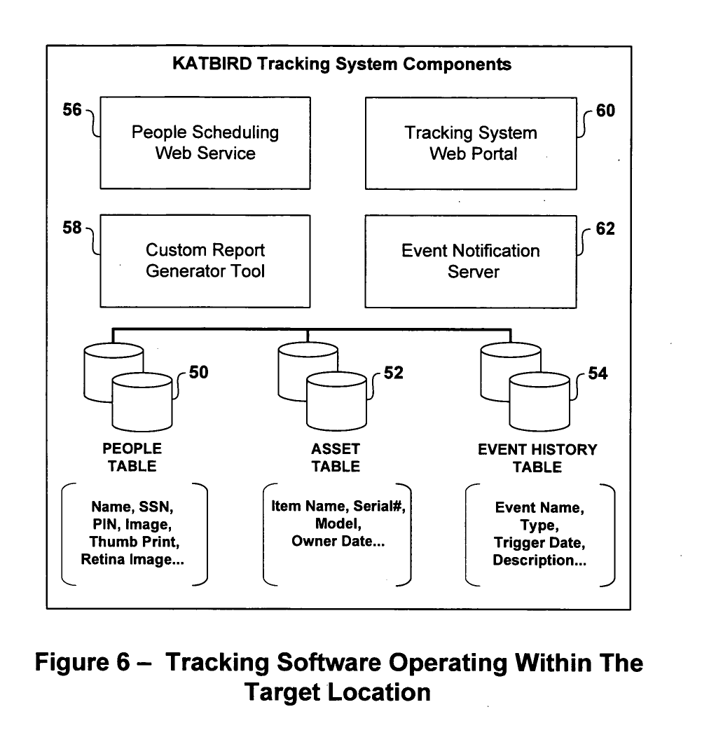

FIG. 6 is a block diagram illustrating the tracking software operating within the target location. The software consists of three tables “PEOPLE” 50, “ASSETS” 52 and “EVENTS” 54 comprising people and asset tracking with event monitoring. The people table stores the scheduled people's data including Name, SSN, id, etc. Assets table 52 stores the company's assets like the computers, mechanical equipments, components, etc. Event table 54 stores the history of events occurred during the life cycle of any particular location like alarms, evacuation, registration, etc. The People Scheduling Web Service Component 56 is another interface for the users who doesn't want to use the legacy software interfacing with their ERP system based on the trust relationship issues. Custom Report Generator Tool 58 is used for reporting the stored data in the previously described tables. The tool is not a part of software implementation; it is a package like Crystal Reports that is interfaced with the system. The Katbird Tracking System Web Portal 60 is a world wide web (WWW) form that enables the headquarters and mobile users to access and control the state of the SMS particular to that location. The Event Notification Server 62 is an independent software package which is required to register and monitor primitive/composite events within the location and notify the listeners of the managed region.

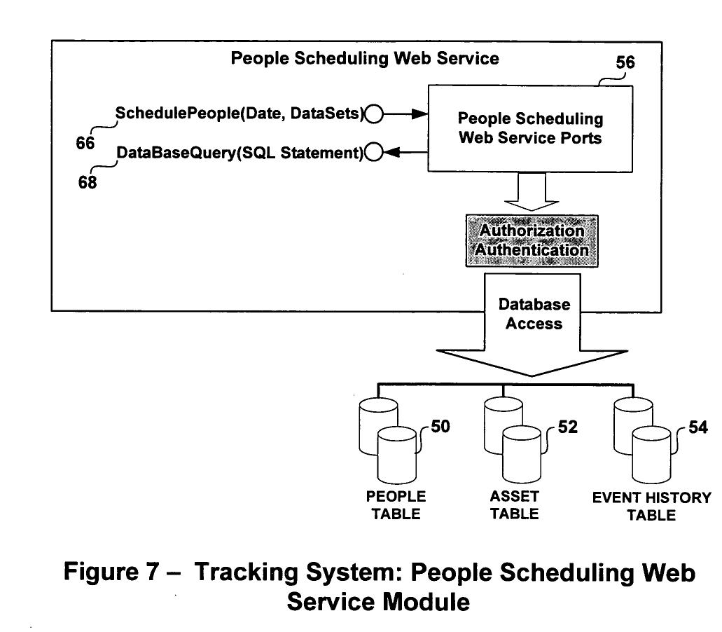

FIG. 7 is a block diagram illustrating the People Scheduling Web Service 56 modular architecture. The service provides two interfaces: “SchedulePeople” 66 and “DatabaseQuery” 68. First interface provides a service for scheduling people. The service takes people data including the binary objects as an input. Without the legacy software, service access requires authorization and authentication. The retrieved trusted data is stored in the people table 50 and a return parameter is sent to the user indicating the operation is successful. The latter interface 68 provides a service for tracking the scheduled people, assets and events. The service takes the query as input and returns the generated people, asset, and event datasets as an output. The query can be a database access statement or a stored procedure in this multi-tiered application.

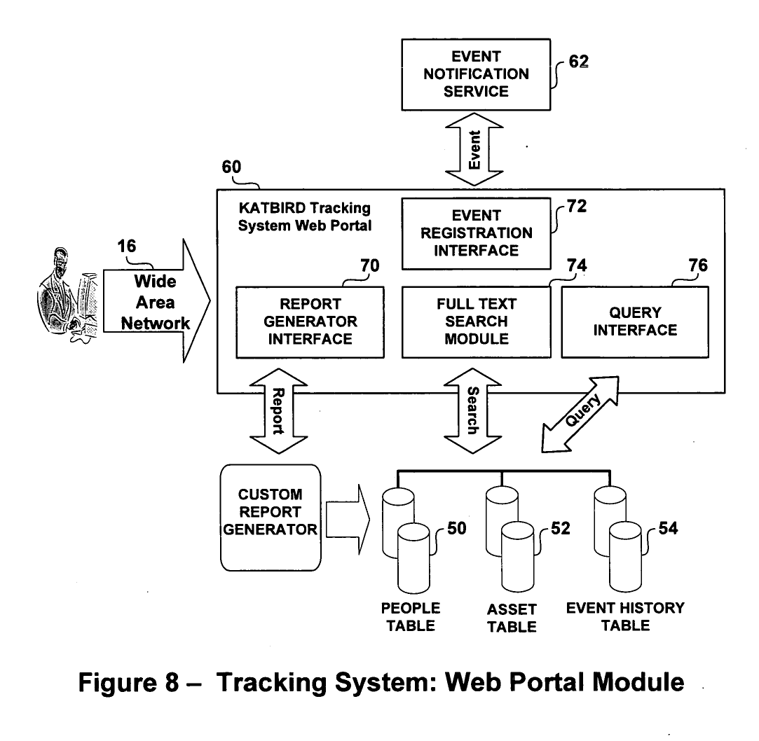

FIG. 8 is a block diagram, illustrating the Tracking Systems Web Portal Module 60. The portal 60 consists of a report generator interface 70 providing mobile reporting functionality for users that are not currently in the SMS location. From this interface the user can access the custom reporting tool and generate user-defined report files that are transferred through the WAN 16 using hyper text transfer protocol (HTTP) and file transfer protocol (FTP) protocols. The interface 70 also provides online reporting where the reports can be visualized from the portal itself. The interface 70 acts as a fully transparent object between the user and the custom reporting tool giving full control to the users for their report functionalities. Similar to the reporting interface, Event Registration interface 72 provides a mobile control of the event notification service within the location. The user can register the primitive and composite events; they can further register the notification and monitoring functionalities provided by the service. The event registration interface 72 gives the mobile users full control for the provided service. Full text search module 74 provides the search capability for the users by enabling the text based queries. This capability is provided if and only if the three tables described previously are indexed using all the relevant terms of interest. The query module 76 provides a complete database access to the users where they can update, insert and retrieve data from the SMS target location DBMS (People, Assets, Events).

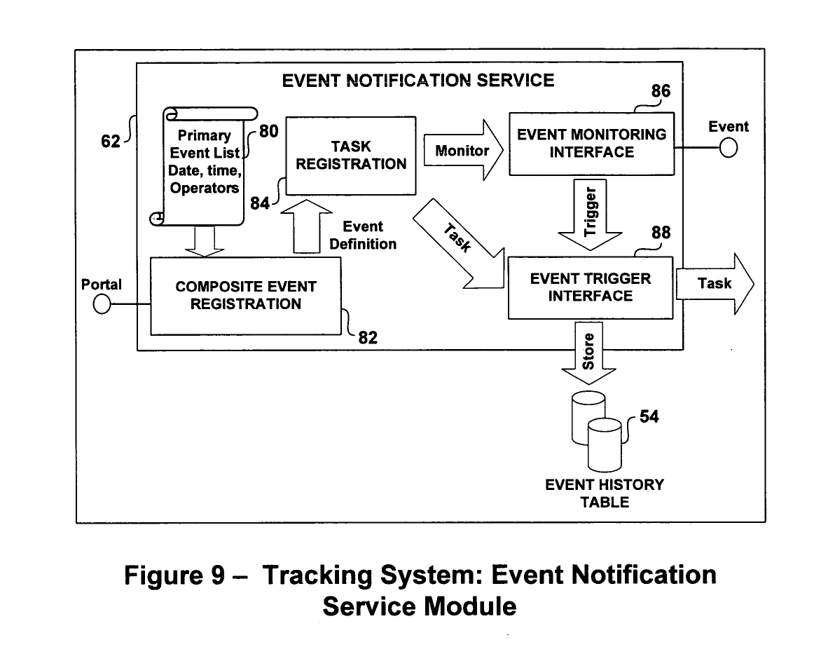

FIG. 9 is a block diagram, illustrating the Tracking Systems Event Notification Service package 62. The service consists of list of pre-defined registered set of events called the primary events 80. From the composite event registration interface 82, user-defined events can be generated using the primitive events and the set of operators. These user-defined events are called the composite events. The pre-defined events can be authentication, photo click, people scheduling, alarm, evacuation, etc. The operators can be union, time interval, selection, periodicity, etc. Users can associate a group of tasks for each user-defined event for the notification functionalities. The task registration interface 84 consists of a pre-defined list of tasks (send mail, insert/delete object, send report, ping, etc.) which are run by the service when the registered event is triggered. The monitoring interface 86 tracks the events received from the access control regions, the events are received and stored in XML format. The trigger interface 88 provides the state machine for triggering the registered events. After the events are fired, they are inserted to the event history table 54 by the trigger interface using their attributes and time instance information. The registered tasks also run from this interface.

Although the present invention has been described in terms of specific embodiments, it is anticipated that alterations and modifications thereof will no doubt become apparent to those skilled in the art. It is therefore intended that the following claims be interpreted as covering all such alterations and modifications as fall within the true spirit and scope of the invention.

We claim:

1. A platform independent distributed system that constructs a security management infrastructure for different locations by integrating people information, asset information, and event information, the system comprising:
a control manager, regulating access to assets information by interfacing with and bridging a biometric means;
a tracking model, comprising a web portal for mobile control of the system; a custom report generation tool means for providing report generation and viewing interfaces with auto-scheduling for periodic generation; an event notification service means for registering, monitoring, and storing primary/composite events into a modeled event history database;
a client side middleware interfacing with multi-tier enterprise models as a business object comprising cross domain security management and monitoring.

2. The platform independent distributed system, as recited in claim 1, wherein the control manager consists of an interface with a touch screen resistance panel displaying the stored images of each person assigned to a particular location;
and wherein for authorization, each person accessing the asset information, clicks on his/her image and confirm his/her identity;
and wherein for authentication, after clicking on the corresponding image, each person enters his/her personal identification number on the touch screen keypad in order to finalize his/her approval for clearance.

3. The platform independent distributed system, as recited in claim 1, wherein the control manager consists of an interface with a secure keyless biometric access control system that requires a fingerprint to gain access to a critical business asset.

4. The platform independent distributed system, as recited in claim 1, wherein the control manager consist of an interface with a secure keyless biometric access control system that provides scanning a retina for gaining access to the asset.

5. The platform independent distributed system, as recited in claim 1, wherein the custom report generation tool contains a plurality of formats for the user to generate a customized report, a report generation interface and a report viewer interface.

6. The platform independent distributed system, as recited in claim 5,
wherein the user selects and runs a report from a menu of several standard, pre-defined reports;
wherein the user modifies the date range for the report by selecting from a list of pre-defined ranges;
wherein the user modifies selection criteria (the criteria for which records will be included in the report) and wherein the selection criteria include, but are not limited to name, surname, social security number, assigned location, duty and date of employment, authorization code, customer status, customer class, day of call, phone number, duration, organization, service, site, state, station, time of call, transaction class, trunk, trunk group, etc;
wherein the user customizes various features of the report, such as its type (summary, detail, frequency or most/least), the columns to be used and their relative positions, etc.

7. The platform independent distributed system, as recited in claim 1, wherein the web portal comprises:
a query interface for the modification, extraction and insertion of data into managed tables;
a report generation Interface for communication with the custom report generation tool and obtaining reports online;
a full text search Interface integrated on the managed data for text based queries;
an event registration Interface for primitive and composite event scheduling with task allocation.

8. The platform independent distributed system, as recited in claim 1, wherein the web service software package comprising:
a people scheduling interface for making daily/monthly/yearly reservations for people at managed locations;
a tracking interface for querying the managed data within the location.

9. The platform independent distributed system, as recited in claim 1, wherein the event notification service includes:
a predefined list of primitive events and operators;
a composite event registration interface for defining and scheduling composite events;
a task allocation interface for associating particular tasks with the stored composite events;
an event monitoring interface for listening to the primitive events through external ports;
an event trigger interface for firing the primitive/composite events, storing them in to the history database and running the registered tasks.

10. The platform independent distributed system, as recited in claim 1, wherein the client side middleware comprising:
database access and configuration interface for extracting personal data from enterprise resource planning (ERP) database management system (DBMS);
daily/Monthly/Yearly People Scheduling Interface for periodic reservations;
SQL Editor for querying the ERP DBMS;
object upload interface for extracting the binary personal data from the DBMS.

11. A platform independent distributed system that constructs a security management infrastructure for different locations by integrating people information, asset information, and event information, the system comprising:
at a central location:
a database management system (DBMS);
a middleware interfacing with multi-tier enterprise models as a business object comprising cross domain security management and monitoring;
at a remote location:
a control manager, regulating access to assets information by interfacing with and bridging a biometric means;
a tracking model, comprising a web portal for mobile control of the system; a custom report generation tool means for providing report generation and viewing interfaces with auto-scheduling for periodic generation; an event notification service means for registering, monitoring, and storing primary/composite events in to a modeled event history database.

12. The platform independent distributed system, as recited in claim 11, wherein the system contains multiple remote locations, and wherein at each remote location the system includes: a separate control manager, regulating access to assets information by interfacing with and bridging a biometric means; and a separate tracking model, comprising a web portal for mobile control of the system; a custom report generation tool means for providing report generation and viewing interfaces with auto-scheduling for periodic generation; an event notification service means for registering, monitoring, and storing primary/composite events in to a modeled event history database.

13. The platform independent distributed system, as recited in claim 12, wherein the control managers consists of an interface with a touch screen resistance panel displaying the stored images of each person assigned to a particular location.

14. The platform independent distributed system, as recited in claim 12, wherein the control managers consists of an interface with a secure keyless biometric access control system that requires a fingerprint to gain access to a critical business asset.

15. The platform independent distributed system, as recited in claim 12, wherein the control managers consist of an interface with a secure keyless biometric access control system that provides scanning a retina for gaining access to the asset.

16. The platform independent distributed system, as recited in claim 12, wherein the custom report generation tools contain a plurality of formats for the user to generate a customized report, a report generation interface and a report viewer interface.

17. The platform independent distributed system, as recited in claim 12,
wherein the user selects and runs a report from a menu of several standard, pre-defined reports.

18. The platform independent distributed system, as recited in claim 12, wherein the web portal comprises:
a query interface for the modification, extraction and insertion of data into managed tables;
a report generation Interface for communication with the custom report generation tool and obtaining reports online;
a full text search Interface integrated on the managed data for text based queries;
an event registration Interface for primitive and composite event scheduling with task allocation.

19. The platform independent distributed software tracking model, as recited in claim 12, wherein the web service software package comprises:
a people scheduling interface for making daily/monthly/yearly reservations for people at managed locations;
a tracking interface for querying the managed data within the location.

20. The platform independent distributed system, as recited in claim 12, wherein the event notification service includes:
a predefined list of primitive events and operators;
a composite event registration interface for defining and scheduling composite events;
a task allocation interface for associating particular tasks with the stored composite events;
an event monitoring interface for listening to the primitive events through external ports;
an event trigger interface for firing the primitive/composite events, storing them in to the history database and running the registered tasks.

21. The platform independent distributed system, as recited in claim 12, wherein the client side middleware comprising:
database access and configuration interface for extracting personal data from an enterprise resource planning (ERP) database management system (DBMS);
daily/Monthly/Yearly People Scheduling Interface for periodic reservations;
SQL Editor for querying the ERP DBMS;
object upload interface for extracting the binary personal data from the DBMS.
